(19) United States
(12) Patent Application Publication
(10) Pub. No.: US 2005/0251799 A1
(43) Pub. Date: Nov. 10, 2005

(54) Method of updating firmware

(75) Inventor: Chun-Cheng Wang, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/121,995

(22) Filed: May 5, 2005

(30) Foreign Application Priority Data
May 6, 2004 (TW) 93112829

(51) Int. Cl. G06F 9/44

(52) U.S. Cl. 717/168

(57) ABSTRACT

A method of updating firmware, for updating a plurality of electronic devices is disclosed. The method includes: first, providing a firmware update files having firmware program codes, each firmware program code respectively corresponds to one of the electronic devices; then, decompressing a part of the firmware update file, and writing into the corresponding electronic device; then, checking whether a writing error occurs; and, checking whether the update is complete; if not, repeat the step of writing.

This application claims the benefit of Taiwan application Serial No. 093112829, filed May 6, 2004, the subject matter of which is incorporated herein by reference.

### BACKGROUND OF THE INVENTION

1. Field of the Invention

The invention relates in general to a method of updating, and more particularly to a method of updating firmware.

2. Description of the Related Art

Electronic devices advance at a tremendous pace. Often by the time a user gets an electronic product, the product software version has become outdated, and thus requires newer software versions for add-on features or bug fixes. Conventional method of correcting bugs or adding new features is through updating firmware.

To update firmware, firmware update files and firmware codes are required. Firmware update files are executed under operating systems, such as Windows, DOS and Linux, to write the firmware codes into flash memory of electronic devices.

However, under the conventional method of updating firmware, only one electronic device can be updated at a time. Thus, when there are numerous electronic devices of varying models, the time and process required for updating firmware can be long and exhaustive.

Furthermore, the firmware codes in recent electronic devices are becoming bigger in size; for instance, the firmware codes for a DVD recorder nowadays is over 1 M bits, rendering firmware update under DOS impossible.

### SUMMARY OF THE INVENTION

It is therefore an object of the invention to provide a method of updating firmware, capable of updating multiple electronic devices simultaneously while running under an operating system with limited memory.

The invention achieves an above-identified object by providing a method of updating firmware, for updating a plurality of electronic devices. The method includes: first, providing a firmware update file of having a plurality of firmware program codes, where each of the firmware program codes respectively corresponds to one of the electronic devices; then, decompressing a part of the firmware update file, for writing into the corresponding electronic device to perform an update; next, checking whether a writing error occurs; finally, checking whether the update is complete, if not, return to the step of writing.

The invention achieves another above-identified object by providing a method of generating firmware update file. The method includes: first, providing the firmware program codes; next, entering a version parameter and a model number parameter corresponding to each of the firmware program codes, and performing error checking; then, compressing the firmware program codes; and finally, generating the firmware update file according to the compressed firmware program codes.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is flow diagram illustrating a method of generating firmware update file according a preferred embodiment of the invention.

FIG. 2 is flow diagram illustrating a method of updating firmware according to an embodiment of the invention.

FIG. 3 shows illustration of a computer system applied in the method of the embodiment.

### DETAILED DESCRIPTION OF THE INVENTION

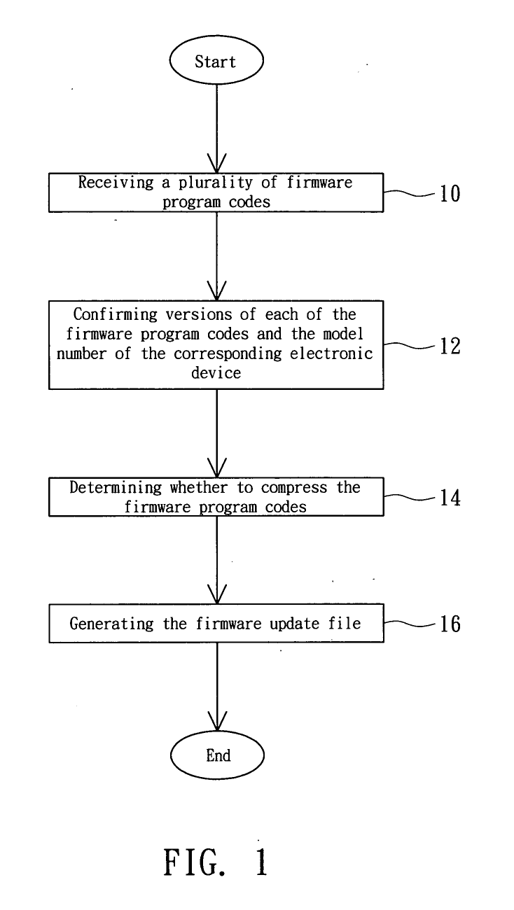

FIG. 1 is flow diagram illustrating a method of generating firmware update file according a preferred embodiment of the invention. Under this embodiment of the invention, the method of generating firmware update file involves using a program to automatically generate a firmware update file that contains a plurality of firmware program codes, in order to update a plurality of electronic devices, such as DVD ROMs, DVD recorders, or motherboards. First, step 10 is performed to receive a plurality of program codes. The user can enter multiple program codes into the program. Next, step 12 is performed to confirm versions of the firmware program codes and the different parameters of the corresponding electronic device, such as the manufacturer and the model number, are correct. Since the firmware program codes used in electronic devices are different, whether the firmware program codes matching with the electronic devices need to be verified, in order to prevent updating the electronic devices with the wrong version of firmware or with the firmware of a wrong model number.

Next, step 14 is performed to determine whether to compress the firmware program codes. One advantage of compression is so that the firmware update can be performed under DOS environment, and another advantage is to allow the update file to incorporate more types of firmware program codes. While running under DOS environment, only 640 Kbytes of memory are available, yet common DVD recorders have firmware size of greater than 1 Mbytes. Hence, firmware update can not be executed under DOS unless firmware program codes are compressed. Consequently, based on the operating system in question or the number of firmware program codes required for performing the update, users can determine whether to compress the firmware program codes. In this embodiment, the compressed firmware program codes are half the size as compared to the uncompressed counterparts. Thus, compressing allows more program codes to be incorporated in the update file.

Lastly, step 16 is executed to generate the update file, which includes the above-mentioned firmware program codes. The update file can further include an update execution file, depending on the choice of the user.

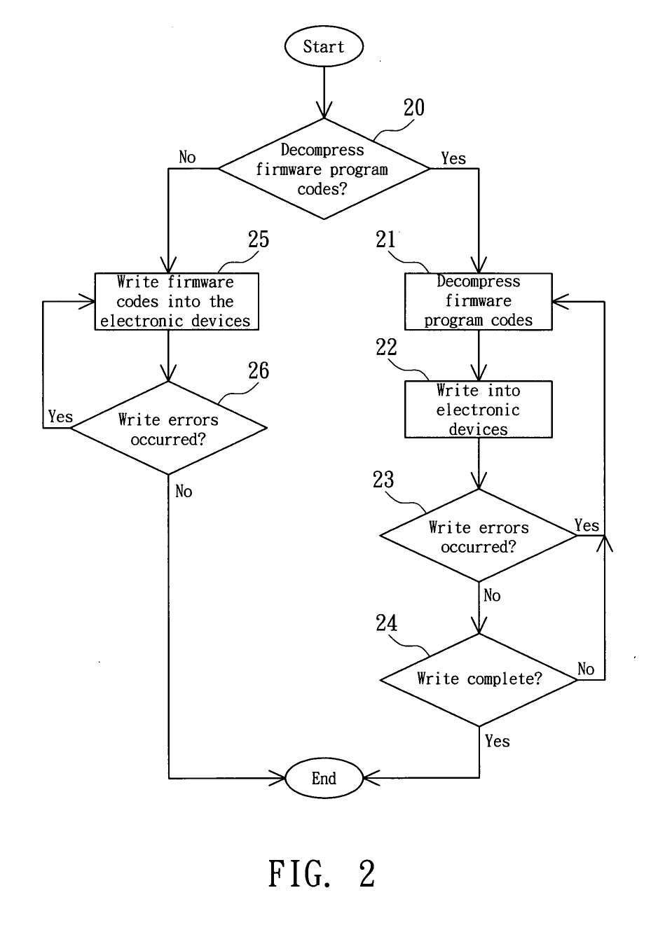

Accordingly, after a number of update files containing the firmware program codes are generated, the corresponding electronic devices can be updated. FIG. 2 is flow diagram illustrating a method of updating firmware according to an embodiment of the invention. First, step 20 is performed to check whether the firmware program codes contained in the update file needs to be decompressed, or in other words, checking whether the firmware program codes is compressed while the update file is generated. If decompression is needed, then step 21 is performed, else step 25 is performed.

In step 21, the firmware program codes in the update file are decompressed. The firmware program codes can be decompressed sequentially, or simultaneously; for instance, under DOS environment, the program codes are decompressed sequentially. Next, step 22 is performed, for writing the data decompressed from step 21 into the corresponding electronic devices. Step 22 can further be performed to check the version of firmware program code with the firmware version contained in the electronic devices, and check whether the firmware program codes accurately corresponds to the electronic devices.

Then, step 23 is performed to check whether a writing error occurs during step 22. To check for errors, the data written during step 22 is being read out from the electronic device, and is evaluated to determine whether the writing was successful. If the writing error occurs during the checking step, then step 21 is returned, and the part of data that is erroneous is being decompressed and re-written into the corresponding electronic device, or in case the program codes are not compressed, then step 22 is returned, and the erroneous part of data is re-written. Then, step 24 is performed to check whether the update if complete, if not, then step 21 is returned to continue decompressing the firmware program codes. Once the update is finished, the method of updating firmware is complete.

Under conditions when firmware program codes do not need to be decompressed, step 25 is performed to directly write the firmware program codes contained in the update file into the corresponding electronic device. In step 25, the multi-thread method can be used to simultaneously write a plurality of firmware program codes into the corresponding electronic devices. Then, step 26 is performed to check whether the writing error occurs. If the writing error occurs, then step 25 is returned to re-write the erroneous part of data, else the method of updating firmware is complete.

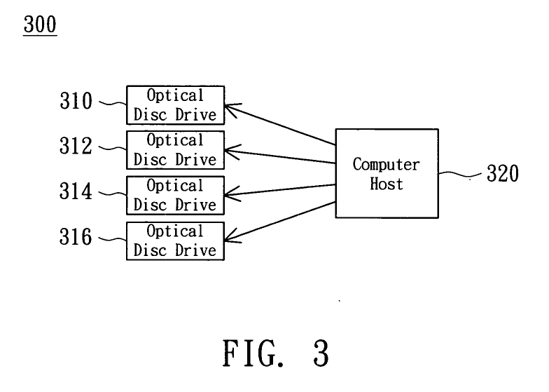

FIG. 3 shows illustration of a computer system 300 applied in the method of the embodiment. Computer system 300 includes a computer host 320, and a number of optical disc drives 310, 312, 314 and 316. If the optical disc drives 310, 312, 314 and 316 are of different model numbers, and all are required to perform firmware update, then the method according to the embodiment of the invention can be utilized to update the firmware of the optical disc drives, thus effectively preventing the exhaustive method of human operation and saving valuable time. In particular, for computer repair departments or the manufacturing departments of electronic devices, the method of the embodiment can be used to improve work efficiency and reduce costs.

The method of updating firmware according to the above mentioned embodiment allows multiple electronic devices to be updated at once, and reduces the need for human operation and loss of valuable time, and more importantly, can work under operating systems despite limited memory constraints.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of updating firmware, for updating a plurality of electronic devices, the method comprising:
(a) providing a firmware update file, the firmware update file having a plurality of firmware program codes, each of the firmware program codes respectively corresponding to one of the electronic devices;
(b) decompressing a part of the firmware update file, for writing into the corresponding electronic device to perform an update;
(c) checking whether a writing error occurs; and
(d) checking whether the update is complete, if not, returning to step b.

2. The method of updating firmware according to claim 1, wherein step (c) comprises reading from the corresponding electronic device the part of the firmware update file written during step (b), for checking whether the writing error occurs.

3. The method of updating firmware according to claim 1, wherein the part of the firmware update file is being re-rewritten into the corresponding electronic device if the writing error occurs during step (c).

4. The method of updating firmware according to claim 1, wherein each of the firmware program codes includes a model number parameter, whereby the correspondence between the electronic devices and the firmware program codes can be known according to the model number parameters.

5. The method of updating firmware according to claim 1, wherein each of the firmware program codes includes a version parameter, whereby the firmware program code, based on the version number parameter, can be determined whether to be newer than a firmware program code already existed in the corresponding electronic device.

6. The method of updating firmware according to claim 1, wherein the firmware update file is generated by:
providing the firmware program codes;
entering a version parameter and a model number parameter corresponding to each of the firmware program codes, and performing error checking;
compressing the firmware program codes; and
generating the firmware update file according to the compressed firmware program codes.

7. The method according to claim 6, wherein the firmware update file further comprises a firmware update execution file.

8. The method of updating firmware according to claim 1 being used in a DOS operating system.

9. A method of updating firmware, for updating a plurality of electronic devices, the method comprising:
providing a firmware update file, the firmware update file having a plurality of firmware program codes, each of the firmware program codes respectively corresponding to one of the electronic devices;
by using a multi-thread procedure, simultaneously writing each of the firmware program codes into the corresponding electronic device; and
checking whether a writing error occur.

10. The method of updating firmware according to claim 9, wherein the checking step comprises reading the part of the firmware update file from the corresponding electronic device written during the writing step, for checking whether the writing error occurs.

11. The method of updating firmware according to claim 9, wherein the part of the firmware update file is being re-rewritten into the corresponding electronic device if the writing error occurs during the checking step.

12. The method of updating firmware according to claim 9, wherein each of the firmware program codes comprises a model number parameter, whereby the correspondence between the electronic devices and the firmware program codes can be known according to the model number parameters.

13. The method of updating firmware according to claim 9, wherein each of the firmware program codes comprises a version parameter, whereby according to the version number parameters, the firmware program codes can be determined whether to be newer than the firmware program codes within the corresponding electronic devices

14. The method of updating firmware according to claim 9, wherein the firmware update file is generated by:
providing the firmware program codes;
entering a version parameter and a model number parameter to each of the corresponding firmware program codes, and performing error checking; and
generating the firmware update file according to the firmware program codes.

15. The method according to claim 14, wherein the firmware update file further comprises a firmware update execution file.

16. The method of updating firmware according to claim 9 being used in a Windows operating system.

17. A method of generating a firmware update file, comprising:
providing a plurality of firmware program codes;
entering a version parameter and a model number parameter to each of the corresponding firmware program codes, and performing error checking; and
determining whether to compress the firmware program codes and generating the firmware update file according to the compressed firmware program codes.

18. The method of generating the firmware update file according to claim 17, wherein the step of determining of whether to compress the firmware program codes depends on an operating system the update file is applied to.

19. The method of generating the firmware update file according to claim 18, wherein the firmware program codes are not compressed if the operating system is the Windows operating system.

20. The method of generating the firmware update file according to claim 18, wherein the firmware program codes are being compressed if the operating system is the DOS operating system.
